(19) United States
(12) Patent Application Publication
(10) Pub. No.: US 2012/0059831 A1
(43) Pub. Date: Mar. 8, 2012

(54) INFORMATION SEARCHING APPARATUS, INFORMATION SEARCHING METHOD, AND COMPUTER PROGRAM

(75) Inventor: Ayahiro NAKAJIMA, Matsumoto-shi (JP)

(73) Assignee: SEIKO EPSON CORPORATION, Tokyo (JP)

(21) Appl. No.: 13/227,366

(22) Filed: Sep. 7, 2011

(30) Foreign Application Priority Data
Sep. 8, 2010 (JP) 2010-200578

(51) Int. Cl. G06F 17/30

(52) U.S. Cl. 707/751; 707/E17.084

(57) ABSTRACT

In response to a search request, the type of the terminal from which the request originated is determined, and a selection history is weighted and accumulated so that the order of the results of a search carried out according to set search conditions varies depending on the selection history. In the case where the type of the request origin terminal is a terminal type in which the number of search results that can be displayed on a single screen is less than in other terminal types or the movement of the screen is more complicated than in other terminal types and search results have been selected across a plurality of screens, a greater weight is applied to the selection history of the selected search results than for other terminal types.

Priority is claimed under 35 U.S.C §119 to Japanese Application No. 2010-200578 filed on Sep. 8, 2010 which is incorporated by reference in its entirety.

### BACKGROUND

1. Technical Field

The present invention relates to information searching apparatuses, information searching methods, and computer programs.

2. Related Art

Nom JP-T-2008-507041 discloses employing a user preference calculation formula as a technique by which an information searching apparatus obtains search results that meet the preferences of a user. This user preference calculation formula obtains search results that meet the preferences of the user by employing the user's search history (that is, a history of the dates and times of searches, terms used in the searches, and so on) as parameters, and setting weights thereon.

In addition to personal computers (called “PCs” hereinafter), mobile telephones, devices called “smartphones”, and so on that feature fully-functioning browsers are also being used as terminals that search for information via the Internet. Although there are various definitions of what constitutes a “smartphone”, here, the term will refer to a mobile terminal whose only web browser is a fully-functioning browser.

There is a large difference in operability between a PC and a smartphone, a mobile telephone, or the like when using a search service that employs a fully-functioning browser. PCs have larger screens compared to smartphones, and the number of search results that can be displayed in a single screen of a PC is much greater than the number of search results that can be displayed by a smartphone. Furthermore, it is easier to scroll through the browser, enter text, and so on using a physical keyboard and a mouse than it is when using a smartphone. With a PC, it is easy to click on links in the second page, the third page, and so on, but this is burdensome when using a smartphone. The operability of a mobile telephone, meanwhile, is even worse than that of a smartphone.

However, while past information searching apparatuses that provide search services using fully-functioning browsers make it possible to search for information through identical operations if the search is carried out from a terminal provided with a fully-functioning browser, such apparatuses do not take into account whether the user's terminal is a PC, a smartphone, or another type of terminal.

### SUMMARY

It is an advantage of some aspects of the invention to provide an information searching apparatus, an information searching method, and a computer program capable of solving the above problems and realizing a search service in accordance with the type of a terminal.

According to a first aspect of the invention, an information searching apparatus is provided, the apparatus including: an information searching unit that searches for information in response to a search request from a user; a selection history accumulation unit that accumulates a selection history of search results from past search requests; a search conditions setting unit that sets a condition for the search carried out by the information searching unit in accordance with the selection history; and a terminal type determination unit that determines the type of the terminal from which the search request originated. The selection history accumulation unit weights and accumulates the selection history so that the order of the results of the search carried out by the information searching unit varies depending on the selection history used by the search conditions setting unit, and in the case where the type of terminal determined by the terminal type determination unit is a terminal type in which the number of search results that can be displayed on a single screen is less than in other terminal types or the movement of the screen is more complicated than in other terminal types and search results have been selected across multiple pages, the selection history accumulation unit applies a greater weight to the selection history of the selected search results than for other terminal types.

With a terminal (such as a smartphone) in which the number of search results that can be displayed on a single screen is less than in other terminal types or the movement of the screen is more complicated than in other terminal types, it is burdensome to display the second page, the third page, and so on, and it is therefore burdensome to select the information on those pages. Therefore, it can be thought that selecting such information displayed on the second or following pages is information important to the point where it is necessary to view that information even if doing so is burdensome. Accordingly, by applying a greater weight to such information than is applied for a terminal (such as a PC) where the number of search results that can be displayed on a single screen is comparatively high or moving the screen is comparatively easy, the likelihood that that information will be displayed in a higher position during the next search is increased. In other words, even if the same information is searched for, the display order of the search results differs depending on the type of the terminal that searched for the information.

Here, it is preferable that a preference information accumulation unit that accumulates information regarding preferences of individual search request engines be further provided; the selection history accumulation unit accumulate the selection history for each search request origin terminal, and the search conditions setting unit can set the search conditions for each individual search request origin in accordance with the information regarding the preferences accumulated in the preference information accumulation unit in addition to the selection history. Accordingly, search results that differ depending not only on the type of the terminal but also on the individual user can be obtained.

Here, it is preferable that the selection history accumulation unit hold, as a table, a relationship between the terminal type determined by the terminal type determination unit and the weight applied to the selection history. Accordingly, even if a new model goes on sale, that model can be accommodated with ease by updating the content of the table, which makes it possible to accommodate many model types.

Here, it is preferable that the selection history accumulation unit apply different weights to the selection history in accordance with the number of search results that can be displayed on a single screen of the terminal whose type has been determined by the terminal type determination unit. Accordingly, it is possible to vary the display order of search results in accordance not only with the amount of information that can be displayed in a single page of the web browser but also with the amount of information that can be displayed in a single terminal screen.

Here, it is preferable that the search conditions setting unit also set the number of search results displayed in a single screen in accordance with the terminal type as determined by the terminal type determination unit. In other words, the pages displayed in the web browser can also be varied based on the type of the terminal.

According to a second aspect of the invention, an information searching method that, in response to a search request from a search request origin, searches for information based on search conditions set in accordance with a selection history of search results from past search requests, is provided. The method includes: determining the type of the request origin terminal based on the search request; and weighting and accumulating the selection history so that the order of the results of the search carried out according to the set search conditions varies depending on the selection history, and in the case where the type of the request origin terminal is a terminal type in which the number of search results that can be displayed on a single screen is less than in other terminal types or the movement of the screen is more complicated than in other terminal types and search results have been selected across a plurality of pages, a greater weight is applied to the selection history of the selected search results than for other terminal types.

According to a third aspect of the invention, a computer program is provided that, when installed in a computer, causes the computer to function as: an information searching unit that searches for information in response to a search request from a search request origin; a selection history accumulation unit that accumulates a selection history of search results from past search requests; a search conditions setting unit that sets a condition for the search carried out by the information searching unit in accordance with the selection history; and a terminal type determination unit that determines the type of the terminal from which the search request originated. The selection history accumulation unit weights and accumulates the selection history so that the order of the results of the search carried out by the information searching unit varies depending on the selection history used by the search conditions setting unit, and in the case where the type of terminal determined by the terminal type determination unit is a terminal type in which the number of search results that can be displayed on a single screen is less than in other terminal types or the movement of the screen is more complicated than in other terminal types and search results have been selected across a plurality of pages, the selection history accumulation unit applies a greater weight to the selection history of the selected search results than for other terminal types.

### BRIEF DESCRIPTION OF THE DRAWINGS

The invention will be described with reference to the accompanying drawings, wherein like numbers reference like elements.

FIG. 1 is a block diagram illustrating an information searching apparatus and an information searching system that includes that information searching apparatus according to a first embodiment of the invention.

FIG. 2 is a flowchart illustrating operations performed by the information searching apparatus illustrated in FIG. 1.

FIG. 3 is a diagram illustrating an example of a table that indicates a relationship between the type of a terminal and a weight applied to a selection history.

FIG. 4 is a block diagram illustrating an information searching apparatus and an information searching system that includes that information searching apparatus according to a second embodiment of the invention.

FIG. 5 is a flowchart illustrating operations performed by the information searching apparatus illustrated in FIG. 4.

### DESCRIPTION OF EXEMPLARY EMBODIMENTS

Hereinafter, embodiments of the invention will be described with reference to the drawings.

### First Embodiment

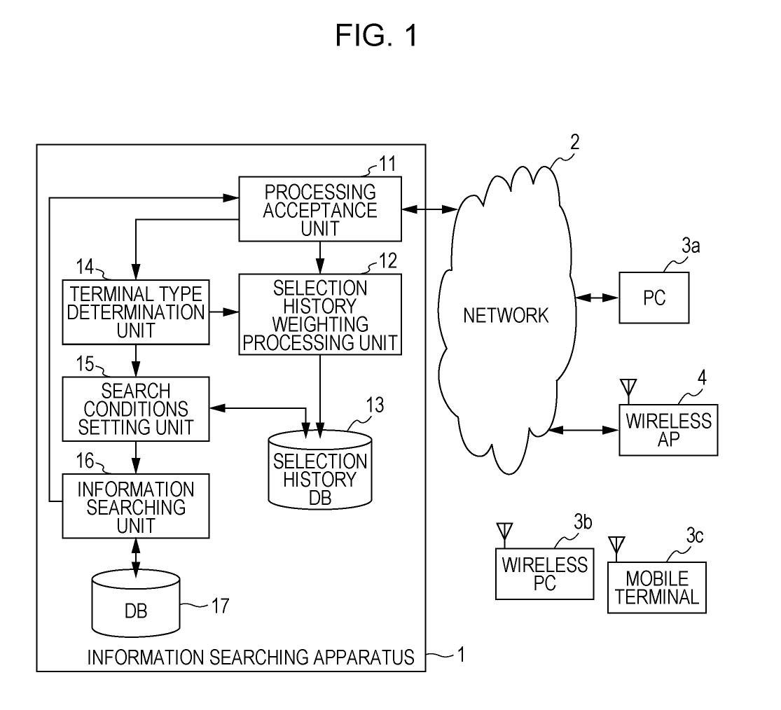

FIG. 1 is a block diagram illustrating an information searching apparatus and an information searching system that includes that information searching apparatus according to a first embodiment of the invention. Hereinafter, descriptions will be given assuming that an information searching apparatus 1 is connected to a network 2, and a user accesses the information searching apparatus 1 via the network 2 from a personal computer (PC) 3a or via a wireless access point 4 and the network 2 from a wireless PC 3b or a mobile terminal 3c. As referred to here, “terminal” indicates a device that is capable of accessing the information searching apparatus 1.

The information searching apparatus 1 includes a processing acceptance unit 11, a selection history weighting processing unit 12, a selection history database 13, a terminal type determination unit 14, a search conditions setting unit 15, an information searching unit 16, and a database 17. The information searching unit 16 and the database 17 configure an information searching unit that searches for information in response to a search request from a user. The selection history weighting processing unit 12 and the selection history database 13 configure a selection history accumulation unit that accumulates a selection history of search results for past search requests. The search conditions setting unit 15 configures a search conditions setting unit that sets conditions for a search carried out by the information searching unit in accordance with a selection history. The terminal type determination unit 14 configures a terminal type determination unit that determines the type of the terminal from which the search request originated.

A server computer is employed as the information searching apparatus 1, and includes hardware such as a CPU, a RAM, a ROM, a hard disk, various types of interfaces, and so on; the functions of the various units are realized through computer programs that operate within a predetermined operating system.

The processing acceptance unit 11 provides an interface for the user, accepts a search request from the user via the network 2, and sends the results of a search carried out by the information searching unit 16 to the terminal of the user via the network 2.

The selection history weighting processing unit 12 weights selection histories and accumulates those histories in the selection history database 13 so that the order of the results of the search carried out by the information searching unit 16 varies depending on the selection history used by the search conditions setting unit 15. Here, in the case where the type of the terminal as determined by the terminal type determination unit 14 is, for example, a smartphone, and thus a lower number of search results can be displayed in a single screen than for other types of terminals or the movement of the screen is more complicated than with other types of terminals, and furthermore, search results have been selected across a plurality of screens, a greater weighting is applied to the selection history of those selected search results than is applied in the case of other terminal types. The terminal types may be generally classified into “PC,” “smartphone,” “mobile telephone with fully-functioning browser,” and so on, or may be classified into their individual model types.

The terminal type determination unit 14 determines the type of terminal from which the request originated based on a search request that has been received by the processing acceptance unit 11. The type of the terminal can be determined using, for example, user-agent information that is present in an http (hypertext transfer protocol) header. Alternatively, a window for inputting the terminal type can be presented when using the information searching apparatus 1, and terminal information obtained therethrough can then be employed.

The search conditions setting unit 15 sets conditions for the search process carried out by the information searching unit 16. The “search conditions” referred to here include not only conditions for accessing the database 17 and carrying out a search, but also include sorting carried out using a user preference calculation formula in which the search itself of the information searching unit 16 is not weighted but the display order of the results of that search is weighted.

The information searching unit 16 executes a search of the database 17 under the conditions set by the search conditions setting unit 15.

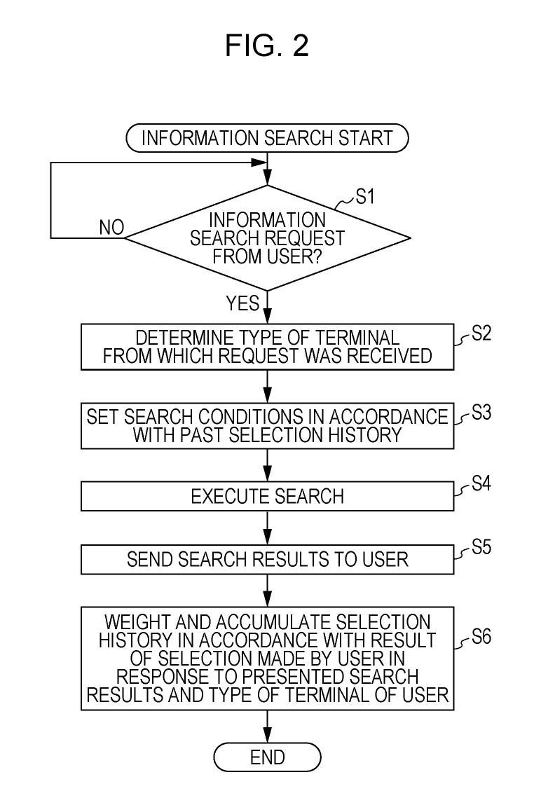

FIG. 2 is a flowchart illustrating operations performed by the information searching apparatus 1 illustrated in FIG. 1. The processing acceptance unit 11 accepts an information search request from the user (step S1). When an information search request has been made (Y in step S1), the terminal type determination unit 14 determines the type of the terminal from which the request originated. The search conditions setting unit 15 reads out a past selection history from the selection history database 13, and sets the search conditions in accordance with that selection history (step S3). The information searching unit 16 executes a search of the database 17 in accordance with the search conditions set by the search conditions setting unit 15 (step S4). The information searching unit 16 sends the search results to the user's terminal via the processing acceptance unit 11 (step S5). When the user selects the information of one of the search results that have been sent, that selection is communicated to the selection history weighting processing unit 12 by the processing acceptance unit 11. The selection history weighting processing unit 12 then weights the selection history in accordance with the search results of the user and the type of the user's terminal, and accumulates that selection history in the selection history database 13 (step S6).

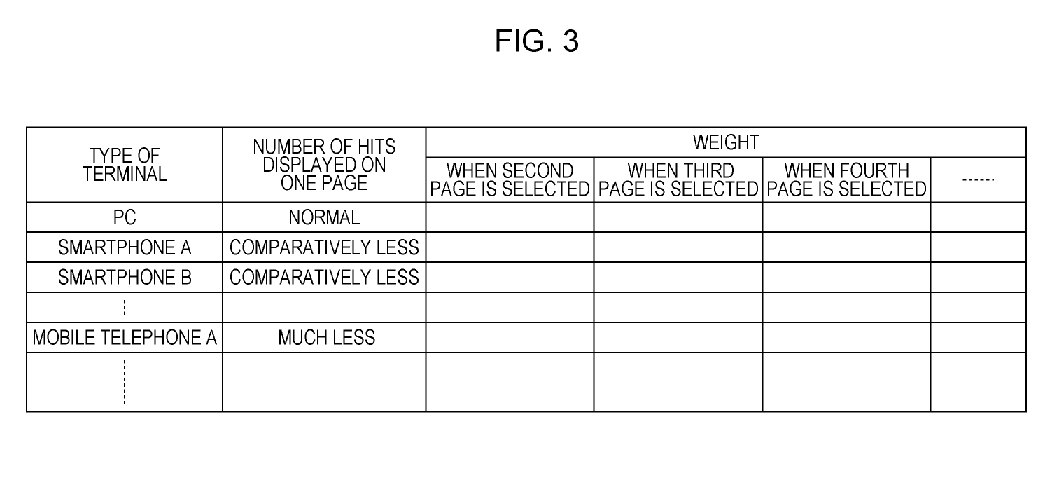

FIG. 3 is a diagram illustrating an example of a table that indicates a relationship between the type of a terminal and a weight applied to a selection history. In the case where the terminal type is “PC,” weighting is carried out in accordance with the number of times a piece of information has been selected, but there is no need to change the weight based on page differences. On the other hand, with respect to mobile terminals such as smartphones, a greater weight is applied when the second or following page of a webpage has been selected than is applied in the case of a PC. This weight will be referred to as “bonus points.” With respect to mobile terminals such as smartphones, different bonus points can be allocated on a page-by-page basis. Same bonus points can also be allocated within the same page. Meanwhile, with respect to different terminal types, the amount of bonus points can be changed depending on differences in the amount of information that can be displayed by that terminal.

The selection history weighting processing unit 12 can also apply different weights to selection histories in accordance with the number of search results that can be displayed in a single screen of a terminal as determined by the terminal type determination unit 14. The search conditions setting unit 15 can set the number of search results displayed in a single window in accordance with the terminal type as determined by the terminal type determination unit 14.

### Explanation of Effects

According to the aforementioned configuration, the display order of search results is not changed at the point in time that the search for information is carried out, but when another search for information is carried out thereafter, it is highly likely that the display order of the search results will be changed depending on whether the terminal is a PC or a mobile terminal such as a smartphone.

Note that the “weighting” referred to here is carried out not only on the information itself (or to be more accurate, the link to that information), but is also carried out on a category selected by the user; in the case of cuisine, for example, the category may be “Japanese,” “Italian,” or the like. This technique itself is known as PageRank®. This technique is an algorithm for determining weights for web pages, and is used by the search engine Google® to obtain results that are appropriate for search terms. In this technique, higher rankings are given to information or the categories thereof, which increases the likelihood that that information or category will be displayed in a higher position.

According to the aforementioned embodiment, in the case where information on the second page, the third page, or so on has been selected in a terminal such as a smartphone, where the number of search results that can be displayed on a single page is comparatively low or moving the screen is comparatively burdensome, that information or the category to which that information belongs is ranked higher, which makes it possible to increase the likelihood that that information will be displayed in a higher position during the next search.

### Second Embodiment

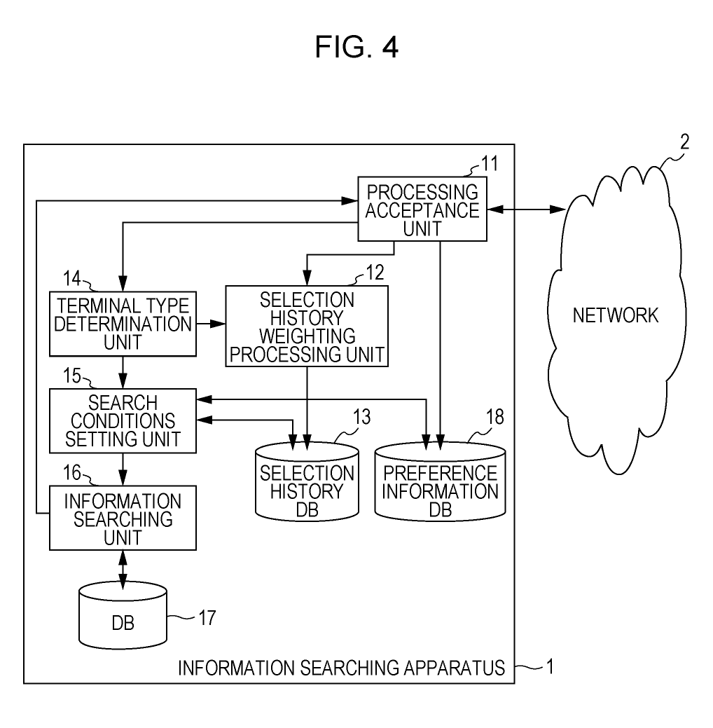

FIG. 4 is a block diagram illustrating an information searching apparatus 1 and an information searching system that includes that information searching apparatus 1 according to a second embodiment of the invention. This embodiment differs from the first embodiment illustrated in FIG. 1 in that a preference information database 18 is further provided.

In the aforementioned first embodiment, the weighting is not carried out in accordance with the preferences of individual users. Practically speaking, however, it is desirable to carry out weighting in accordance with the preferences of individual users. Accordingly, the information searching apparatus 1 illustrated in FIG. 4 includes the preference information database 18, which accumulates information regarding the preferences of individual users. Furthermore, selection histories are accumulated in the selection history database 13 on a user terminal-by-user terminal basis. The search conditions setting unit 15 sets the conditions of the search carried out by the information searching unit 16 in accordance with the information regarding preferences that are accumulated in the preference information database 18 in addition to the selection histories from the selection history database 13.

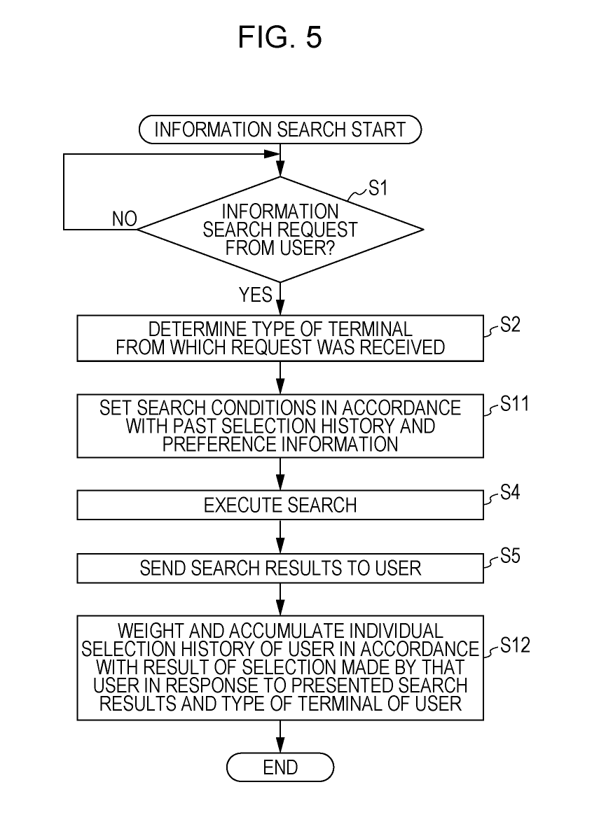

FIG. 5 is a flowchart illustrating operations performed by the information searching apparatus 1 illustrated in FIG. 4. In these operations, the search conditions setting unit 15 sets the search conditions in accordance with the history of past searches carried out by the user and the preference information (step S11), instead of step S3 carried out in the flowchart illustrated in FIG. 2. In addition, the selection history weighting processing unit 12 weights and accumulates the individual selection history of a user in accordance with the result of a selection made by that user in response to search results that have been sent and in accordance with the type of the user's terminal, instead of step S6 carried out in the flowchart illustrated in FIG. 2 (step S12).

What is claimed is:

1. An information searching apparatus comprising:
an information searching unit that searches for information in response to a search request from a search request origin;
a selection history accumulation unit that accumulates a selection history of search results from past search requests;
a search conditions setting unit that sets a condition for the search carried out by the information searching unit in accordance with the selection history; and
a terminal type determination unit that determines the type of the terminal from which the search request originated,
wherein the selection history accumulation unit weights and accumulates the selection history so that the order of the results of the search carried out by the information searching unit varies depending on the selection history used by the search conditions setting unit,
wherein the weight is determined based on the terminal type.

2. The information searching apparatus according to claim 1, further comprising:
a preference information accumulation unit that accumulates information regarding preferences of individual users,
wherein the selection history accumulation unit accumulates the selection history for each search request origin terminal; and
the search conditions setting unit sets the search conditions for each individual search request origin in accordance with the information regarding the preferences accumulated in the preference information accumulation unit in addition to the selection history.

3. The information searching apparatus according to claim 1,
wherein the selection history accumulation unit holds, as a table, a relationship between the terminal type determined by the terminal type determination unit and the weight applied to the selection history.

4. The information searching apparatus according to claim 1,
wherein the selection history accumulation unit applies different weights to the selection history in accordance with the number of search results that can be displayed on a single screen of the terminal whose type has been determined by the terminal type determination unit.

5. The information searching apparatus according to claim 1,
wherein the search conditions setting unit sets the number of search results displayed in a single screen in accordance with the terminal type as determined by the terminal type determination unit.

6. An information searching method that, in response to a search request from a search request origin, searches for information based on search conditions set in accordance with a selection history of search results from past search requests, the method comprising:
determining the type of the request origin terminal based on the search request; and
weighting and accumulating the selection history so that the order of the results of the search carried out according to the set search conditions varies depending on the selection history,
wherein the weight is determined based on the terminal type,
wherein the each of above steps are executed by processor.

7. A non-transitory computer readable medium that, when installed in a computer, causes the computer to function as:
an information searching unit that searches for information in response to a search request from a search request origin;
a selection history accumulation unit that accumulates a selection history of search results from past search requests;
a search conditions setting unit that sets a condition for the search carried out by the information searching unit in accordance with the selection history; and
a terminal type determination unit that determines the type of the terminal from which the search request originated,
wherein the selection history accumulation unit weights and accumulates the selection history so that the order of the results of the search carried out by the information searching unit varies depending on the selection history used by the search conditions setting unit,
wherein the weight is determined based on the terminal type.
